(19) United States
(12) Patent Application Publication
(10) Pub. No.: US 2018/0145571 A1
(43) Pub. Date: May 24, 2018

(54) EFFICIENT INDUCTION MOTOR

(71) Applicant: SANKAR HAZRA, Bishnupur (IN)

(72) Inventor: SANKAR HAZRA, Bishnupur (IN)

(21) Appl. No.: 15/556,621

(22) PCT Filed: Jul. 14, 2016
(86) PCT No.: PCT/IN2016/000184

§ 371 Date: Sep. 12, 2017

(30) Foreign Application Priority Data
Jul. 22, 2015 (IN) 797/KOL/2015

(51) Int. Cl. H02K 17/30; H02K 17/16; H02K 17/12; H02K 3/28

(52) U.S. Cl. CPC H02K 17/30; H02K 17/16; H02P 2207/01; H02K 3/28; H02K 17/12

(57) ABSTRACT

This invention aims at developing an Induction Motor that consumes less power than existing Induction Motors. An efficient Induction motor comprises a stator that includes three field windings and a rotor that includes rotor conductors short-circuited at both ends by end rings located at both ends of rotor. A field winding comprises a number of pairs of North pole and South pole. There are three full-wave rectifiers. Each of the three full-wave rectifiers converts a phase current of a three phase alternating current supply into a unidirectional current varying with time and delivers the converted current exclusively to a field winding. As a result, poles of the field winding generate fluctuating magnetic flux. A rotor conductor cuts said fluctuating magnetic flux thereby inducing an emf in said rotor conductor and consequently generating current in it. The direction of said magnetic flux and the direction of said current flowing in said rotor conductor are perpendicular to each other. Said rotor conductor moves in a direction perpendicular to both the direction of said magnetic flux and said rotor conductor current thereby rotates the rotor.

### TECHNICAL FIELD

This invention is related to the field of Electrical Engineering, bringing about an improvement of technology of induction motors.

### BACKGROUND ART

The present invention aims to solve a problem arising out of a shortcoming of technology used in a conventional three phase AC induction motor, very common in industry. But before going for a discussion on background art, it is necessary to quote a portion of Appendix to Chapter 4 of PCT INTERNATIONAL SEARCH AND PRELIMINARY EXAMINATION GUIDELINES as follows.

“A 4.05[2], Since the reader is presumed to have . . . technical knowledge appropriate to the art, and it is not . . . case permitted to make amendments which go beyond the disclosure . . . the examiner should not invite the applicant . . . to interest anything in the nature of a treatise or research report or explanatory . . . which is obtainable . . . from textbooks or is otherwise well known . . . the examiner should not invite the applicant to provide a detailed description of the content . . . . It is sufficient . . . only the most appropriate . . . one need to be referred to. On the other hand, the examiner should not invite the applicant to delete any such unnecessary matter except when it is very extensive.”

It is obvious from above that a discussion on background art in this case should be made very carefully for, most of it is obtainable from text books, and it is not necessary to refer to any Patent document. However a few words about AC induction motors are required, which cannot be avoided, for a discussion not obtainable in text books that points out scope for present invention.

In case of conventional three phase ac induction motors, double layer stator windings are generally used. In a slot of stator core, conductors of two different phases are located. Phase currents are alternating in nature and there is a phase difference between two phases.

Under this circumstance, irrespective of whatever is done regarding sequence of phases, changing direction of flow of phase currents etc, it is not possible to avoid a situation in which magnetic field generated by one phase will, at least partially, neutralize magnetic field generated by other phase for an appreciable fraction of time.

It is obvious from above that resultant magnetic field generated by conductors conducting two alternating phases of currents located in a slot of stator will be weak for an appreciable fraction of time of operation compared to magnetic field which would have resulted had there been no neutralization of concerned magnetic fields. It is obvious that other two combinations of phases of the stator supplied by three phase alternating current also suffer from identical shortcomings.

A rotating magnetic field is generated in the stator of a conventional Induction Motor which brings about rotation of rotor as known to anyone skilled in concerned art. The rotating magnetic field consists of component resultant magnetic fields referred in the previous paragraph which combine together to form the rotating magnetic field, which in turn, are generated by interaction of elementary magnetic fields produced by individual phases of current, as discussed in previous paragraph. Instead of basing the discussion on rotating magnetic field as a whole, a study based on components of the rotating magnetic field is taken up to study how neutralization of magnetic fields, as discussed in the previous paragraph, affects performance of AC Induction Motors.

Magnitude of force exerted on a rotor conductor of an Induction Motor can be determined by the equation F=BIL, where,

F is the force exerted on a rotor conductor at an instant in Newtons, B is the flux density in air gap in Teslas at that instant, I is the current flowing through the rotor conductor in amperes at that instant and, L is the length of the rotor conductor in meters.

The resultant magnetic flux being weak for an appreciable fraction of time, flux density B assumes small numerical values for an appreciable fraction of time.

The formula cited above establishes that force applied on a rotor conductor will have low values for an appreciable fraction of time of operation in case of a conventional AC Induction Motor and a fraction of power consumed for magnetic fields generated by stator windings is wasted affecting efficiency of the motor.

### DISCLOSURE OF INVENTION

The shortcoming of existing Induction motors is overcome by the present invention, which provides an Induction motor powered by three phase unidirectional currents varying with time. For this, each phase of a three phase alternating current supply is converted into a unidirectional phase current varying with time as it flows through a full-wave rectifier. The motor comprises a stator and a rotor. The stator is having three field windings. Each field winding is having a number of pairs of North pole and South pole. A full-wave rectifier delivers a unidirectional phase current varying with time exclusively to a field winding.

The rotor has a number of conductors located in slots on outer periphery of the rotor. Rotor conductors are short-circuited by two end rings located on two sides of the rotor.

As current from a rectifier flows to a field winding, poles produce fluctuating magnetic flux. The fluctuating magnetic flux emitted by a pole is cut by a rotor conductor. The fluctuating magnetic flux induces emf in the rotor conductor. The emf so induced in a rotor conductor, generates current flowing along the length of the conductor and in a direction perpendicular to the direction of magnetic flux emitted by the pole. Under the combined action of the magnetic flux and current in the rotor conductor, the rotor conductor moves in a direction perpendicular to both the direction of said flux and the direction of said current thereby rotating the rotor.

In a motor developed by present invention, magnetic field generated by a pole of the stator as a phase current flows through it leading to consumption of power, is fully utilized to to produce mechanical power, unlike to a conventional alternating current induction motor wherein the magnetic field generated as a result of flow of an alternating phase current in a pole of the stator is, for a substantial fraction of cycle of the phase, neutralized, at least partially, by the magnetic field generated as current of another phase flows through adjacent field winding leading to lowered output of the motor.

Reference, will now be made to the accompanying drawings to assist understanding the invention.

### BRIEF DESCRIPTION OF DRAWINGS

FIG. 1 shows circuit diagram when phase R of the three phase alternating current supply is the source of power.

FIG. 2 shows circuit diagram when phase Y of the three phase alternating current supply is the source of power.

FIG. 3 shows circuit diagram when phase B of the three phase alternating current supply is the source of power.

FIG. 4 illustrates variation of output current of the rectifier with time.

FIG. 5 shows layout of poles of the stator core on the plane of the paper.

FIG. 6 shows a part of a lamination of the stator core and a part of a lamination of the rotor core.

FIG. 7 shows an end ring of rotor core and cooling fan blades.

FIG. 8 shows a sectional view of the end ring and a blade.

FIG. 9 shows rotor conductors in slots of a part of rotor with the end ring removed.

### BEST MODE FOR CARRYING OUT THE INVENTION

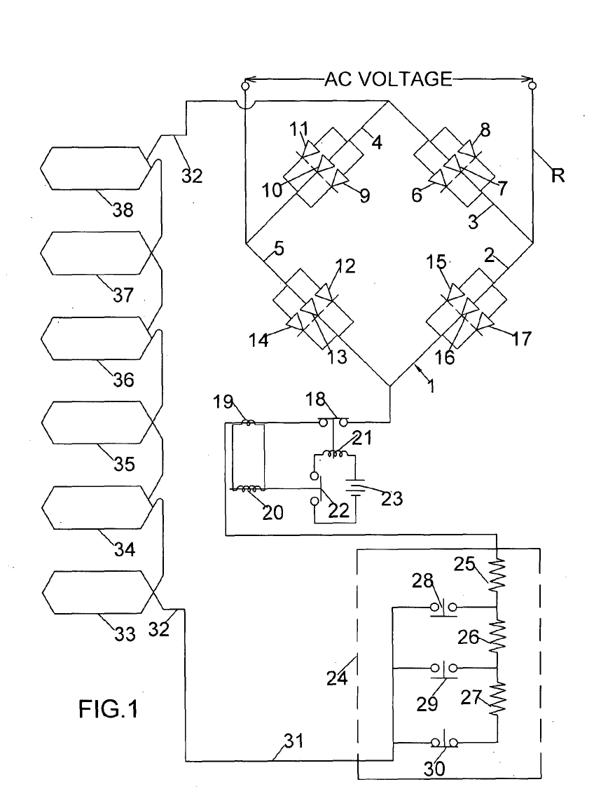

FIG. 1 shows circuit diagram when phase R of a three phase alternating current supply is providing power for the rectifier 1. The rectifier 1 comprises four arms 2, 3, 4 and 5 respectively. Arm 2 has three diodes 15, 16 and 17 connected in parallel. Arm 3 has three diodes 6, 7 and 8 connected in parallel. Arm 4 has three diodes 9, 10 and 11 connected in parallel. Arm 5 has three diodes 12, 13 and 14 connected in parallel.

Depending on the load, the number of diodes used in each of four arms of the rectifier is to be selected.

Use of a number of diodes connected in parallel to constitute an arm of a full-wave rectifier is in practice and is not an invention.

There is a circuit breaker 18 that makes and breaks current in normal operation condition. In case of a fault, excessive current flows through the current transformer 19 as a result of which the relay coil 20 closes the trip coil 21 circuit by closing contacts 22. The trip coil 21 circuit is powered by a dc supply 23. As the trip coil 21 circuit is closed, the circuit breaker 18 trips.

Current flows to a variable resistor 24. The variable resistor 24, designed to limit current of the motor at start and control current at later stages, essentially comprises three resistances 25, 26 and 27 respectively connected in series. It also comprises three circuit breakers 28, 29 and 30 respectively. There is a conductor 31 connected to each of circuit breaker 28, circuit breaker 29, and circuit breaker 30, for leading current out of the variable resistor 24.

One circuit breaker of the variable resistor 24 is closed at a time and other two circuit breakers are open. Depending on the circuit breaker that is closed, resistance of the circuit is decided. As obvious from this figure, with circuit breaker 28 and circuit breaker 29 open, current has to traverse all the three resistances of the variable resistor 24 under existing state.

Current flowing out of the variable resistor 24 is led to the field winding 32. The field winding 32 comprises six poles 33, 34, 35, 36, 37 and 38 respectively.

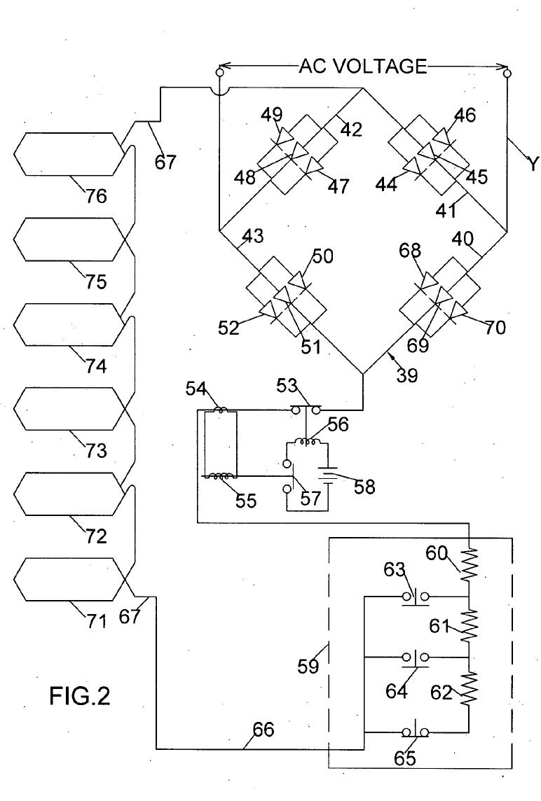

FIG. 2 shows circuit diagram when phase Y of a three phase alternating current supply is providing power for the rectifier 39. The rectifier comprises four arms 40, 41, 42 and 43 respectively. Arm 40 has three diodes 68, 69 and 70 connected in parallel. Arm 41 has three diodes 44, 45 and 46 connected in parallel. Arm 42 has three diodes 47, 48 and 49 connected in parallel. Arm 43 has three diodes 50, 51 and 52 connected in parallel.

Depending on the load, the number of diodes used in each of four arms of the rectifier is to be selected. Use of a number of diodes connected in parallel to constitute an arm of a full-wave rectifier is in practice and is not an invention.

There is a circuit breaker 53 that makes and breaks current in normal operation condition. In case of a fault, excessive current flows through the current transformer 54 as a result of which the relay coil 55 closes the trip coil 56 circuit by closing contacts 57. The trip coil 56 circuit is powered by a dc supply 58. As the trip coil 56 circuit is closed, the circuit breaker 53 trips.

Current flows to a variable resistor 59. The variable resistor 59 designed to limit current of the motor at start and control current at later stages, essentially comprises three resistances 60, 61 and 62 respectively connected in series. It also comprises three circuit breakers 63, 64 and 65 respectively. There is a conductor 66 connected to each of circuit breaker 63, circuit breaker 64, and circuit breaker 65, for leading current out of the variable resistor 59.

One circuit breaker of the variable resistor 59 is closed at a time and other two circuit breakers are open. Depending on the circuit breaker that is closed, resistance of the circuit is decided. As obvious from this figure, with circuit breaker 63 and circuit breaker 64 open, current has to traverse all the three resistances of the variable resistor 59 under existing state. Current flowing out of the variable resistor 59 is led to the field winding 67. The field winding 67 comprises six poles 71, 72, 73, 74, 75 and 76 respectively.

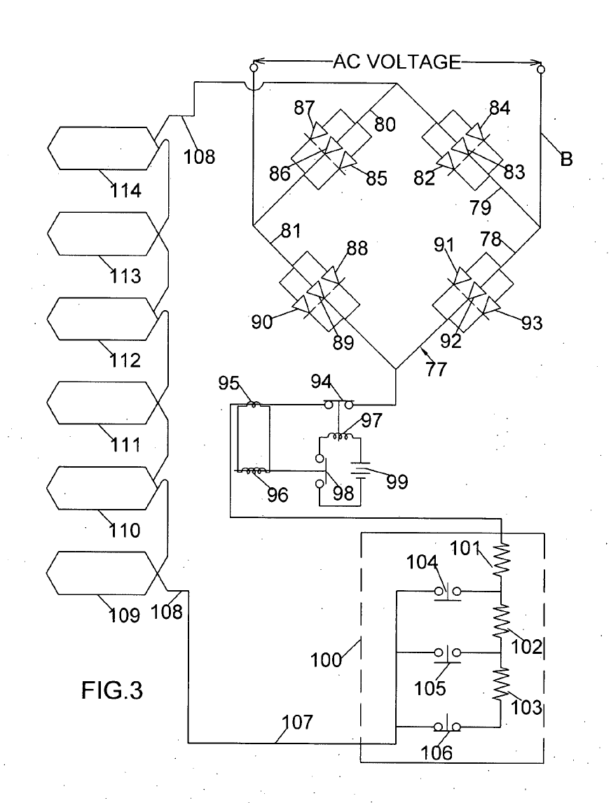

FIG. 3 shows circuit diagram when phase B of a three phase alternating current supply is providing power for the rectifier 77. The rectifier 77 comprises four arms 78, 79, 80 and 81 respectively. Arm 78 has three diodes 91, 92 and 93 connected in parallel. Arm 79 has three diodes 82, 83 and 84 connected in parallel. Arm 80 has three diodes 85, 86 and 87 connected in parallel. Arm 81 has three diodes 88, 89 and 90 connected in parallel. Depending on the load, the number of diodes used in each of four arms of the rectifier is to be selected.

Use of a number of diodes connected in parallel to constitute an arm of a full-wave rectifier is in practice and is not an invention.

There is a circuit breaker 94 that makes and breaks current in normal operation condition. In case of a fault, excessive current flows through the current transformer 95 as a result of which the relay coil 96 closes the trip coil 97 circuit by closing contacts 98. The trip coil 97 circuit is powered by a dc supply 99. As the trip coil 97 circuit is closed, the circuit breaker 94 trips.

Current flows to a variable resistor 100. The variable resistor 100 designed to limit current of the motor at start and control current at later stages, essentially comprises three resistances 101, 102 and 103 respectively connected in series. It also comprises three circuit breakers 104, 105 and 106 respectively. There is a conductor 107 connected to each of circuit breaker 104, circuit breaker 105, and circuit breaker 106, for leading current out of the variable resistor 100.

One circuit breaker of the variable resistor 100 is closed at a time and other two circuit breakers are open. Depending on the circuit breaker that is closed, resistance of the, circuit is decided. As obvious from this figure, with circuit breaker 104 and circuit breaker 105 open, current has to traverse all the three resistances of the variable resistor 100 under existing state.

Current flowing out of the variable resistor 100 is led to the field winding 108. The field winding 108 comprises six poles 109, 110, 111, 112, 113 and 114 respectively.

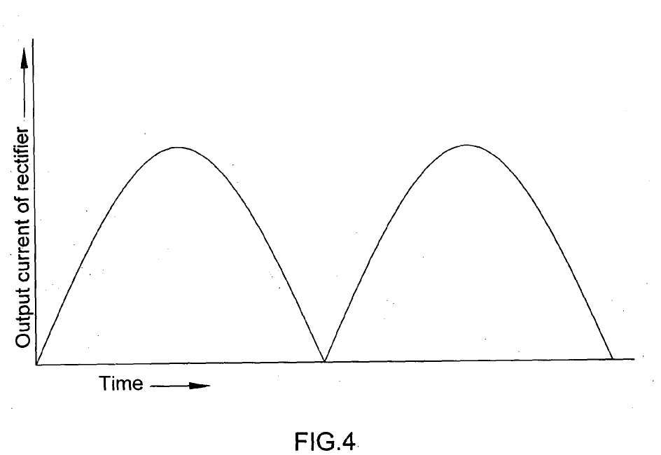

FIG. 4 illustrates variation of output current of a full-wave rectifier with time.

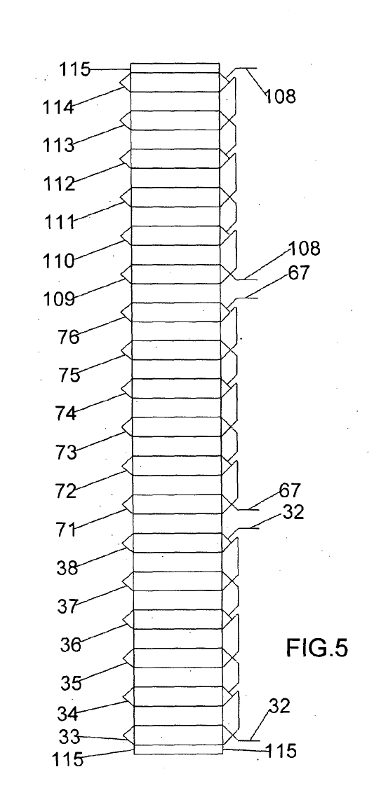

FIG. 5 shows layout of poles of stator core in the plane of the paper. It shows field winding 32 comprising North poles 33, 35 and 37 respectively. Field winding 32 comprises South poles 34, 36 and 38 respectively. FIG. 5 shows field winding 67 comprises North poles 71, 73 and 75 respectively. Fielding winding 67 comprises South poles 72, 74 and 76 respectively. FIG. 5 shows field winding 108 comprising North poles 109, 111 and 113 respectively. Field winding 108 comprises South poles 110, 112 and 114 respectively. FIG. 5 shows stator core 115 flattened on the plane of the paper.

As shown in FIG. 5 and as revealed above in connection with FIG. 5, North poles and South poles are located alternately in the stator core.

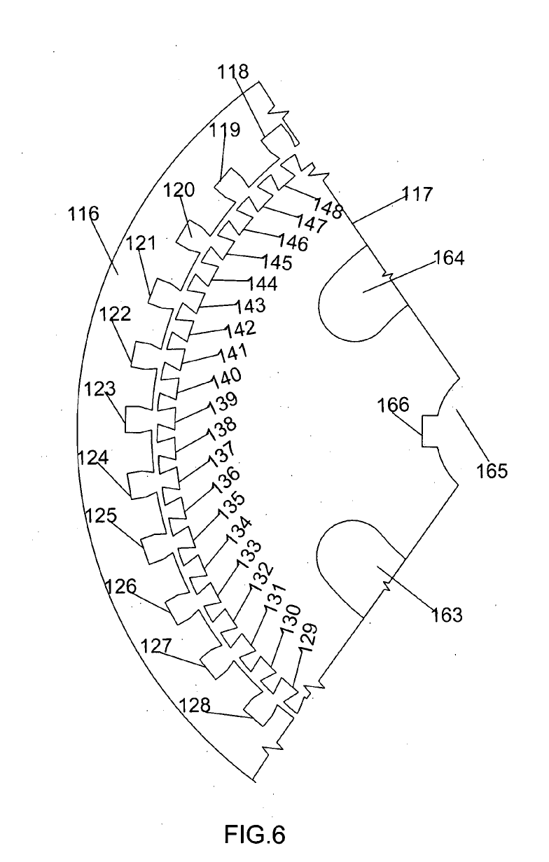

FIG. 6 shows a part of a lamination 116 of stator core and a part of a lamination 117 of rotor core. It shows slots 118, 119, 120, 121, 122, 123, 124, 125, 126, 127 and 128 respectively for a field winding in the lamination 116 of stator core. FIG. 6 shows rotor core lamination 117 is having slots 129, 130, 131, 132, 133, 134, 135, 136, 137, 138, 139, 140, 141, 142, 143, 144, 145, 146, 147 and 148 on outer periphery for conductors. FIG. 6 shows portions of vent slots 163 and 164 respectively. It shows shaft bore 165 and keyway 166.

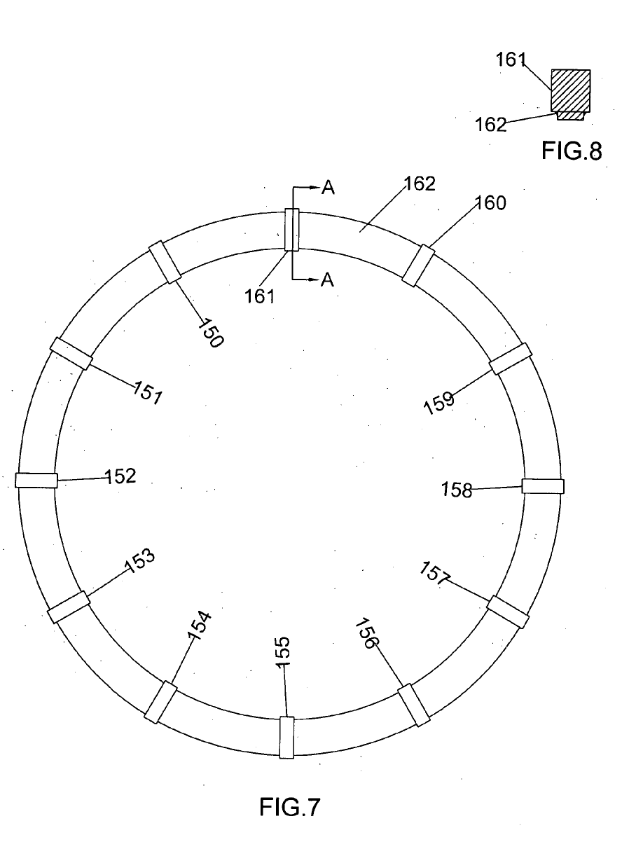

FIG. 7 shows one of the two end rings which are located on both sides of the rotor core and which short-circuit rotor conductors. FIG. 7 shows end ring 162. Its shows cooling fan blades 150, 151, 152, 153, 154, 155, 156, 157, 158, 159, 160 and 161.

FIG. 8 shows sectional view along section AA of FIG. 7. It shows end ring 162 and blade 161. FIG. 8 Shows blade 161 welded to the end ring 162.

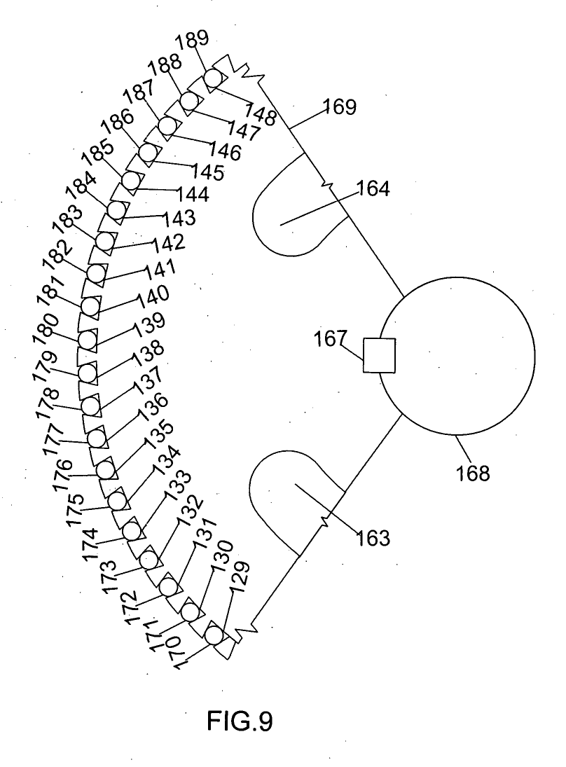

FIG. 9 Shows a part of rotor with end ring removed and having rotor conductors. It shows rotor conductor 170, 171, 172, 173, 174, 175, 176, 177, 178, 179, 180, 181, 182, 183, 184, 185, 186, 187, 188 and 189 located in slots 129, 130, 131, 132, 133, 134, 135, 136, 137, 138, 139, 140, 141, 142, 143, 144, 145, 146, 147 and 148 respectively in rotor 169. FIG. 9 shows vent holes 163 and 164. It shows rotor shaft 168 and Key 167.

The stator core is housed in a frame as in case of a conventional ac Induction motor. The stator core encircles the rotor including the rotor core. Both stator core and the rotor core are made up of laminations insulated from each other. There are slots located parallel to the axis of rotation of the rotor, on the inner surface of stator core for field windings. There are slots located parallel to the axis of rotation of the rotor, on the outer surface of the rotor core for conductors.

The rotor core is mounted on a shaft directly in case of small motors. The shaft is held in position by bearings located on both sides of the rotor core.

### INDUSTRIAL APPLICABILITY

The motor developed by present invention will be used widely in industry. It will be used as drive for belt conveyors and elevators transporting materials. It will be used in Petroleum refineries and other chemical industries as drive for process pumps. It will be used as drive for pumps of Pumping Stations of Oil pipe lines and Gas pipelines, to name some of its applications.

I claim:

1. An Efficient Induction Motor comprising a stator and a rotor, said stator holding three field windings, each field winding comprising a number of pairs of North pole and South pole located at inner periphery of stator, said rotor having a number of conductors located near its outer periphery, each of the three field windings characterized by being powered by a unidirectional phase current varying with time exclusively supplied for said field winding, a pole of stator belonging to individual field winding comprising a number of poles distributed over stator core, said pole of stator conducting a unidirectional single phase current varying with time, magnetic fields generated by said phase current flowing in a field winding not being neutralized even partially by magnetic fields generated by another phase current flowing in another field winding.

2. An Efficient Induction Motor as claimed in claim 1, wherein said unidirectional phase current varying with time is supplied exclusively to a field winding by a full-wave rectifier designed for converting a phase current of a three phase alternating current supply to a unidirectional phase current varying with time.

3. An Efficient Induction Motor as claimed in claim 1 wherein said North Poles and said South Poles are located alternately in Stator Core.

4. An Efficient Induction Motor as claimed in claim 1 wherein stator core comprises laminations insulated from each other having slots located parallel to the axis of rotation of rotor core along its inner periphery for field windings.

5. An Efficient Induction Motor as claimed in claim 1 wherein rotor core comprises laminations insulated from each other having a number of slots located near its outer periphery for rotor conductors running parallel to axis of rotation of the rotor core, said rotor conductors being short-circuited by two end rings located at both sides of rotor core.

6. An Efficient Induction Motor essentially comprising a stator and a rotor, said stator including three field windings, each of said field windings comprising a number of pairs of North pole and South pole, each of said field windings characterized by receiving current from a full-wave rectifier, said full-wave rectifier designed for converting a phase current of a three phase alternating current supply to a unidirectional phase current varying with time to be delivered exclusively to a field winding, said rotor having a number of conductors.

7. An Efficient Induction Motor as claimed in claim 6 wherein a pole of stator belonging to individual field winding comprising a number of poles distributed over stator core, said pole of stator conducting a unidirectional single phase current, magnetic fields generated by said single phase current flowing in a field winding not being neutralized by magnetic fields generated by another phase current flowing in another field winding.

8. An Efficient Induction Motor as claimed in claim 6 wherein said North Poles and said South Poles are located alternately in stator core.

9. An Efficient Induction Motor as claimed in claim 6 wherein stator core comprising laminations insulated from each other having slots located parallel to the axis of rotation of rotor core along its inner periphery for field windings.

10. An Efficient Induction Motor as claimed in claim 6 wherein rotor core comprising laminations insulated from each other having a number of slots located near its outer periphery for rotor conductors running parallel to axis of rotation of the rotor core, said rotor conductors being short-circuited by two end rings located at both side of rotor core.
